(19) United States
(12) Patent Application Publication
(10) Pub. No.: US 2014/0090761 A1
(43) Pub. Date: Apr. 3, 2014

(54) TIRE TREAD FOR A TRAILER-TYPE HEAVY VEHICLE AND MOLDING COMPONENT

(71) Applicants: Benoit Foucher, Clermont-Ferrand (FR); Hervé Bechon, Clermont-Ferrand (FR); Philippe Mansuy, Clermont-Ferrand (FR)

(72) Inventors: Benoit Foucher, Clermont-Ferrand (FR); Hervé Bechon, Clermont-Ferrand (FR); Philippe Mansuy, Clermont-Ferrand (FR)

(73) Assignee: Compagnie Generale Des Establissments Michelin, Clermont-Ferrand (FR)

(21) Appl. No.: 13/984,719

(22) PCT Filed: Feb. 15, 2012
(86) PCT No.: PCT/EP12/52631

§ 371 Date: Nov. 26, 2013

(30) Foreign Application Priority Data
Feb. 17, 2011 (FR) 1151312

(51) Int. Cl. B60C 11/13; B29D 30/06

(52) U.S. Cl. CPC B60C 11/1218; B29D 30/0681
USPC 152/209.18; 249/187.1

(57) ABSTRACT

A tread and a tire for a heavy vehicle, and a molding element therefor, this tread comprising a plurality of sipes of circumferential overall orientation and of width (Li), each of these sipes extending into the depth of the tread over a depth (P) that is less than the mean thickness (E) of the tread, each sipe being extended radially inwards by a channel having lateral walls that, when the tread has become partially worn, delimit a new groove, these lateral walls connecting to a bottom , each sipe connecting together a plurality of drainage wells, each formed in the thickness of the tread opening via a first opening onto the tread surface the maximum dimension of which is at least equal to twice the width of the sipe and via a second opening into a channel; for each sipe of circumferential overall orientation, there is at least one drainage well in the contact patch and, in the continuation of each drainage well, a protrusion on the bottom of the channel.

### BACKGROUND

1. Field

The invention relates to the treads of tires for heavy vehicles and, more particularly, heavy vehicles of the trailer type. It also relates to the tires provided with such treads.

2. Description of Related Art

It is known that the grip of a tire on a roadway covered with water is strongly connected with the presence of cavities which serve notably to drain away the water present between the tire and the roadway. In order to meet this performance requirement in terms of grip or road holding, it is known practice for the treads of heavy vehicles of the trailer type to have a tread pattern design made up of circumferential ribs delimiting grooves, the transverse geometry (which means the geometry viewed in the plane of section containing the axis of rotation of the tire) of the grooves being suited to avoiding the retention or jamming of stones in these grooves and thus to avoiding the bottoms of the grooves and the internal reinforcing structure of the tire situated radially on the inside of the tread from being damaged.

In addition, it is known that the rate of wear of a tire tread for a heavy vehicle can be reduced when this tread is provided with a compact tread pattern and the dissipation of energy generated within this tread is also reduced when this tread is provided with a compact tread pattern. What is meant here by a “tread pattern” is the formation and arrangement of raised elements (such as blocks or ribs) delimited by grooves formed by molding. What is meant in the present application by a “compact tread pattern” is a tread pattern that has a low (i.e. at most 10%) void ratio, expressed as the volume of voids with respect to the total volume of rubber available to be worn away, and also a tread pattern that has a large contact area for contact with the roadway when the tire is running along this roadway. This latter feature manifesting itself in there being a maximum percentage surface area of material in contact with the ground with respect to the surface area of the contact patch, this representing a percentage of at least 90%.

One solution for increasing the amount of material in contact with a roadway for a given width of tread is to widen each rib axially as far as possible towards the outside of the tread (forming what is known as the shoulders of the tire), but it has been found that adding material to this part of the tire can lead to an increase in the temperature of the shoulders of the tire.

Another solution, described notably in patent U.S. Pat. No. 4,703,787, is to make the tread pattern compact by reducing the groove to rubber ratio in the new state by replacing each groove with an alternation of circumferentially oriented sipe and of cavities opening onto the tread surface. These cavities on average have widths comparable with those of the grooves that they replace.

A sipe here means the space delimited by walls of material, the mean distance between the said walls being suited to these walls of material touching during running so that the sipe is thus closed. However, this tread pattern, although compact, does not prevent the appearance of certain forms of wear associated with what is referred to as “scrubbing”. An increase in the rate of wear of the tread is thus noted (this rate being expressed as the ratio between the loss of material to the distance traveled) as is an increase in the rolling resistance, i.e. an increase in the amount of energy dissipated during running.

### SUMMARY

It is an object of the invention to propose a tread pattern that reduces the abovementioned disadvantages.

To this end, the invention proposes a tread for a tire of a heavy vehicle, this tread having a volume of rubber to be worn away during running and a mean thickness E measured from a tread surface in the new state, this tread surface being intended to come into contact with a roadway. This tread comprises a plurality of sipes of circumferential overall orientation and of width Li, each of these sipes extending into the depth of the tread over a depth P that is less than the mean thickness E of the tread, each sipe being extended radially inwards by a channel of maximum width Lc that is greater than the width Li of the incision and of height Hc. This channel has lateral walls that are intended, when the tread has become partially worn, to delimit a new groove of maximum width Lc. The lateral walls of the channel connect to a bottom of the channel. Furthermore, each sipe connects together a plurality of drainage wells, each drainage well formed in the thickness of the tread opening via a first opening onto the tread surface via an opening the maximum dimension of which is at least equal to twice the width Li of the sipe and via a second opening into a channel. This tread is characterized in that there is, for each sipe of circumferential overall orientation, at least one drainage well in the contact patch during running and in that, in the continuation of each drainage well, a protrusion is formed on the bottom of the channel into which the said drainage well opens, this protrusion having a height Hp that is less than the height Hc of the channel and a width Lp that is less than the maximum width Lc of the said channel.

Each liquid drainage well also acts as a ventilation channel placing the inside of the tread in communication with the outside.

The tread pattern design for a tire of a vehicle of the trailer type preferably has no groove which in the new state opens onto the tread surface, so that the tread pattern can be as compact as possible. What is meant by groove is a space formed by molding in the tread, this space having a depth at least equal to 75% of the thickness of the tread (the opposing walls delimiting such a groove are distant from one another such that they cannot come into contact under conditions of use).

The depth Hi of the sipe is at least 20% and at most 70% of the thickness E of the tread.

Each protrusion formed on the bottom of a channel may be continuous or discontinuous.

Preferably, each first opening of each drainage well is of circular shape on the tread surface, with a diameter at least equal to at least five times the width Li of the sipe connecting the said drainage wells.

Preferably, each drainage well is of frustoconical shape, the diameter of the first opening on the tread surface in the new state being greater than the diameter of the second opening into a channel.

In a preferred variant, each sipe, when viewed in cross section, has a zigzag shape or a wavy shape in the thickness of the tread so as to prevent, or at least reduce as far as possible, any ingress of stones into the said sipe as far as the underlying channel.

Advantageously, the protrusion formed in each channel is formed so that it is circumferentially discontinuous, each protrusion being designed to be situated radially under a well so that any object that enters the tread via a well cannot reach the underlying channel.

In one variant of the invention, each well has a frustoconical shape. Preferably, the cross section of the well of frustoconical shape increases towards the tread surface when the tread is in the as new state.

According to another variant of the invention, the length of each protrusion is substantially equal to half the distance between each well.

Preferably, the height Hp of each protrusion formed in a channel is at least equal to 20% of the height of the channel.

More preferably still, the height (Hp) of each protrusion is at most equal to 80% of the height (Hc) of the channel.

Preferably, the width Lp of each protrusion is at least 20% and at most 80% of the width Lc of the said channel.

It is preferable for each protrusion to be positioned on the bottom of the channel (which corresponds to the part delimiting the said channel that is furthest away from the tread surface in the new state) rather than on the lateral walls that delimit the said channel, so as to afford the said bottom more effective protection.

The invention also relates to a tire provided with a tread with at least one sipe as described, this tire being specifically intended to be fitted to a heavy vehicle of the trailer type.

It was found during testing that this tread pattern also generated less road noise.

The invention also relates to a mold element for molding a sipe in a tread for a tire of a heavy vehicle, this element comprising a plurality of blades joined together in such a way as to be able to mold a sipe, each blade having a zigzag geometry in the direction of the height of the element, i.e. in the direction intended to become the direction of the thickness of a tread molded in a mold provided with this mold element, these blades being joined together by pins, these blades and these pins being connected by a continuous bead intended to mold a channel in a tread molded in a mold provided with this mold element, this mold element being such that the continuous bead is provided on its part furthest away from the blades with at least one cavity intended to mold a protrusion in the bottom of the channel molded by the said continuous bead in a tread molded in a mold provided with this mold element, at least one cavity being formed so as to be centred on each pin.

Advantageously, each pin is of frustoconical shape of circular section, the largest-diameter section of these pins being intended to mold a circular orifice on the tread surface.

### BRIEF DESCRIPTION OF DRAWINGS

Other features and advantages of the invention will become evident from the description given hereinafter with reference to the attached figures which, by way of nonlimiting example, show one embodiment of the subject matter of the invention.

FIG. 1 shows a view of part of the tread surface of a tread according to the invention;

FIG. 2 shows a cross section through the tread of FIG. 1, this section being taken on a plane the line of which is represented by the line II-II in FIG. 1;

FIG. 3 shows a view in cross section through the thickness of the tread of FIG. 1, this section being taken on a plane the line of which is represented by the line in FIG. 1;

FIG. 4 shows a view in cross section through the thickness of the tread of FIG. 1, this section being taken on a plane the line of which is represented by the line IV-IV in FIG. 1, this plane of section not sectioning any protrusion;

FIG. 5 shows part of a mold element used for molding a sipe as shown in FIGS. 1 to 3;

FIG. 6 shows the same mold element as the one already shown in FIG. 5, but from a different perspective;

FIG. 7 shows a variant shape of drainage well.

### DETAILED DESCRIPTION OF SPECIFIC EMBODIMENTS

FIG. 1 shows part of the tread surface of a tread of a tire 1 of size 385/55 R 22.5 intended to be fitted to a heavy vehicle of the trailer type. This tire 1 comprises a tread 2 according to the invention having a thickness E of material to be worn away equal to 13.5 mm (this thickness E corresponds to a limit beyond which either the tread has to be renewed or the tire has to be changed. In this FIG. 1, it can be seen that the tread 2 has a tread surface 3 intended to come in contact with a road during running. The tread surface 3 of this tread 2 has a width TW equal to 330 mm, corresponding to the maximum contact width measured in the transverse direction (which means in a direction XX′ parallel to the axis of rotation of the tire) for conditions of use of the tire. It may be seen that this tread comprises five sipes 4 each having a zigzag line on the tread surface 3 and being oriented circumferentially overall so that each makes a complete turn around the tire in the circumferential direction.

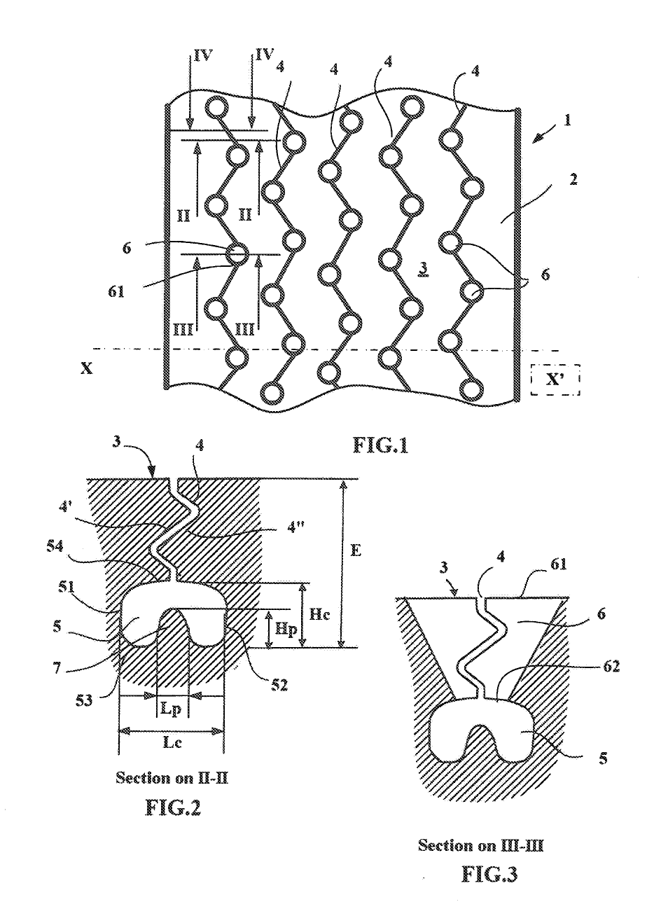

Each of these sipes 4, of mean width equal to 0.4 mm and a maximum depth equal to 8.5 mm, also follows a zigzag path in the direction of the thickness of the tread, as can be seen in FIG. 2. Each sipe 4 communicates with an underlying channel 5 formed within the tread and intended to form a new groove following partial wear by a thickness of tread equal to the depth of the said sipe. These sipes 4 are arranged in such a way that they divide the width of the tread into six regions all having substantially the same transverse dimension.

This channel 5, visible in section in FIG. 2, has a height Hc equal to 5 mm in its tallest part and a maximum width Lc equal to 8 mm. This channel 5 is formed entirely within the tread and follows the line of the sipe of circumferential overall orientation.

Furthermore, this tread 2 is provided with a plurality of drainage wells 6 of radial orientation, namely each orientated in a direction that intersects the axis of rotation, opening via one end onto the tread surface. These drainage wells 6 are arranged on the peaks and the troughs of the zigzag lines formed by the sipes on the tread surface. A first opening 61 of each drainage well 6 has, on the tread surface 3 in the new state, a section of circular shape having a diameter equal to 12 mm. The mean distance in the circumferential direction between two drainage wells 6 for one and the same sipe 4 is equal to 25 mm so that there is always at least one, and preferably at least two drainage well(s) 6 for each sipe 4 in the contact patch.

Each drainage well 6 has, in this particular instance, a frustoconical shape within the thickness of the tread and has a cross section that decreases from the tread surface 3 into the thickness of the tread as shown in FIG. 3. Each drainage well 6 opens via a second opening 62 of circular shape and of diameter equal to 5 mm, into a channel 5.

With all of these sipes 4, drainage wells 6 and channels 5 underlying the tread surface in the new state, the tread 2 according to the invention has a total void volume useful in draining away a liquid present on a roadway which, when considered in relation to the total volume of a tread material that can be worn away, is particularly small because in this particular instance it is equal to 7% (this ratio is very much lower than the usual ratios of tires on the market which are close to or equal to 15%). By virtue of such a ratio and of a tread pattern design according to the invention it is possible, while at the same time complying with driving safety conditions, to put even more material in contact with a roadway and thus increase the wear rate potential of the tire in particular.

FIG. 2 shows in cross section part of the tread 2 of the tire of FIG. 1, this section being taken on a radial plane the line of which is represented by the line II-II in FIG. 1 (a radial plane is a plane containing the axis of rotation of the tire) so that it lies between two drainage wells. In this FIG. 2, the thickness E of tread 2 that can be worn away during running can be seen in cross section. Within this thickness, is visible a sipe 4 which opens onto the tread surface 3, this sipe 4 being formed so that, in the thickness direction, it has a zigzag line so as to mechanically lock together the opposing walls 4′, 4″ that delimit this sipe. This zigzag line into the thickness is combined with the zigzag line in the circumferential direction, further increasing the mechanical locking-together of the opposing walls 4′, 4″ of the sipe 4. This sipe 4 is connected to a circumferentially orientated channel 5 having lateral walls 51, 52 which are intended to become the walls of a new groove when the tread wear is at least equal to the depth Hi of the sipe. This same channel 5 comprises a part 54 radially on the outside and a part radially on the inside that forms a bottom 53, this bottom of the channel being designed to correspond substantially to the wear limit of the tread 2 (which therefore means that it is at a distance equal to the thickness E away from the tread surface 3 in the new state).

Visible in cross section on this bottom 53 of the channel 5 is a protrusion 7 centered transversely on this bottom and having a maximum width Lp equal to 2.5 mm and a maximum height Hp equal to 3 mm, this height being measured up from the bottom 53. In the scenario depicted, each channel 5 on its bottom 53 comprises a plurality of protrusions 7 all having the same dimensions, these protrusions 7 being positioned in such a way as to be in the continuation of each drainage well 6 and spaced apart by a distance less than the mean distance between two successive drainage wells 6 of one and the same sipe 4.

FIG. 3 shows a view in cross section through the thickness of the tread of FIG. 1, this cross section being taken on a plane the line of which is represented by the line of FIG. 1. In this cross section, taken in line with a drainage well 6, it may be seen that this well has a cross-sectional shape which reduces in the direction from the tread surface 3 in the initial state to the channel 5 to which this drainage well 6 is connected by its second opening 62.

FIG. 4 shows a view in cross section through the thickness of the tread of FIG. 1, this section being taken in a plane the line of which is depicted by the line IV-IV in FIG. 1. This section considers a region of discontinuity in the protrusions 7 formed in the bottom of the channel 5.

FIG. 5 shows part of a mold element 40 used to mold a sipe 4 extended by a channel 5 and provided with a plurality of drainage wells 6, this sipe corresponding to the sipe as shown and described in connection with FIGS. 1 to 3.

This mold element 40 comprises a plurality of straight blades 41 joined together so that they can mold a sipe the geometry of which is in the shape of a zigzag in the main direction of the sipe (i.e. in the direction of the line along the tread surface of the tread provided with this sipe). An angle other than 180° is formed between two consecutive straight blades 41. These blades 41 have a part 410 intended to be fixed into a mold for molding a tread according to the invention.

Moreover, each blade 41 has a geometry in the form of a zigzag in the direction of the height of the element, i.e. in the direction intended to become the direction of the thickness of a tread molded in a mold provided with this mold element. These blades 41 are joined together by frustoconical pins 60 of circular section, the largest-diameter section, intended to mold a circular orifice on the tread surface, being positioned on the same side as the parts 410 of the blades 41 that are intended to be fixed to a mold. Furthermore, a continuous bead 50, intended for molding a channel, is formed to join the straight blades 41 and the frustoconical pins 60 together at the end of their narrowest cross section, this continuous bead 50 being formed so that it follows the zigzag line that the blades 41 together form.

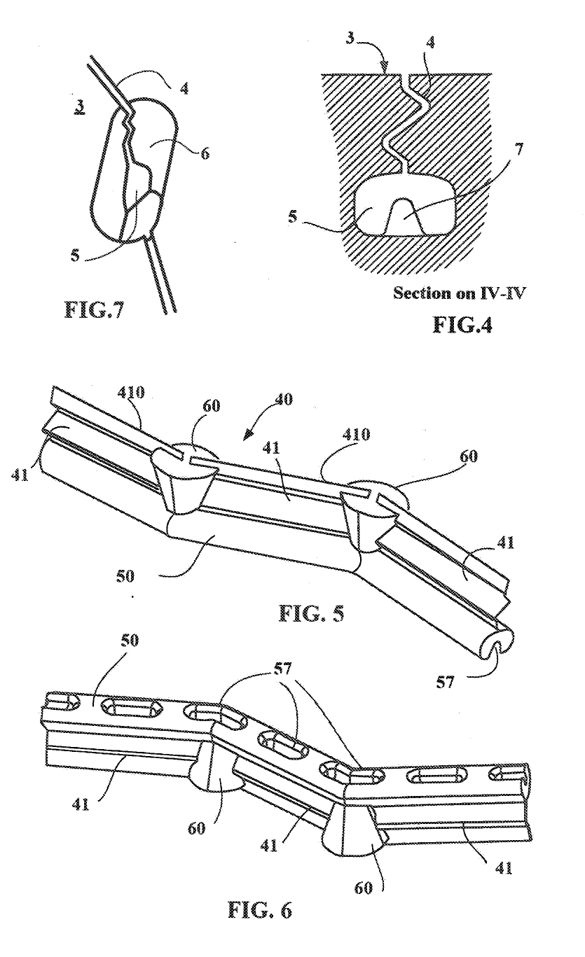

FIG. 6 shows the same mold element 40 as the one already shown in FIG. 5, but from a different perspective. It shows that the continuous bead 50 is provided with a plurality of cavities 57 each intended to mold a protrusion in the bottom of the channel molded by the said continuous bead (these protrusions correspond to the protrusions 7 as shown in connection with FIGS. 2 and 3). These cavities 57 are centred on the frustoconical pins 60 and spaced apart by a suitable distance.

FIG. 7 shows a variant drainage well 6 which on the tread surface 3 has a shape that is elongate in the direction of the sipe 7 on the said surface. The width of this well is at least equal to at least five times the width of the sipe 4. This FIG. 7 shows the channel 5 underlying the tread surface and opening into the drainage well.

The invention is not restricted to the examples described and depicted and various modifications can be made thereto without departing from its scope. In particular, it is possible to form in each channel a single, circumferentially continuous, protrusion that makes a full turn around the tire. It is also possible to create any other form of incision or of drainage well provided that locking means are created on the walls of the sipes in order as far as possible to reduce any relative movement of these walls.

The variant described here shows sipes with zigzag shapes on the tread surface, but it is possible for a person skilled in the art to determine a different shape or different shapes for each sipe, according to the projected use of the tire.

It is also possible to add to the tread in the new state, in addition to the sipes as have just been described, grooves, whether oriented circumferentially and/or transversely, the latter being formed on the edge parts of the tread.

1. A tread for a tire of a heavy vehicle, this tread having a volume of rubber to be worn away during running and a mean thickness E measured from a tread surface when it is in a new state, this tread surface being adapted to come into contact with a roadway, this tread comprising:
a plurality of sipes of circumferential overall orientation and of width (Li), each of these sipes extending into the depth of the tread over a depth (P) that is less than the mean thickness E of the tread,
a channel of maximum width (Lc) that is greater than the width (Li) of the sipe and of height (Hc), extending each sipe radially inward, this channel having:
lateral walls that, when the tread has become partially worn, delimit a new groove of maximum width (Lc),
a bottom of the channel connecting to the lateral walls,
a plurality of drainage wells connected together by each sipe, wherein each drainage well is formed in the thickness of the tread opening via a first opening onto the tread surface the maximum dimension of which is at least equal to twice the width (Li) of the sipe and via a second opening into said channel,
wherein there is, for each sipe of circumferential overall orientation, at least one drainage well in the contact patch during running, and
wherein, in each drainage well, a protrusion is formed on the bottom of the channel into which the said drainage well opens, this protrusion having a height (Hp) that is less than the height (Hc) of the channel and a width (Lp) that is less than the maximum width (Lc) of said channel.

2. The tread according to claim 1, wherein each first opening of each drainage well is of circular shape on the tread surface, with a diameter at least equal to at least five times the width (Li) of the sipe connecting the said drainage wells.

3. The tread according to claim 1, wherein each drainage well is of frustoconical shape, the diameter of the first opening on the tread surface in the new state being greater than the diameter of the second opening opening into a channel.

4. The tread according to claim 1, wherein the height (Hp) of each protrusion formed in a channel is at least equal to 20% of the height of the channel.

5. The tread according to claim 4, wherein the height (Hp) of each protrusion is at most equal to 80% of the height (He) of the channel.

6. A tire provided with a tread according to claim 1, wherein this tire is intended to be fitted to a heavy vehicle of the trailer type.

7. A mold element for molding a sipe in a tread for a tire of a heavy vehicle, comprising:
a plurality of blades joined together in such a way as to be able to mold a sipe, each blade having a zigzag geometry in the direction of the height of the element, i.e. in the direction intended to become the direction of the thickness of a tread molded in a mold provided with this mold element,
pins joining together said blades,
a continuous bead connecting said blades and pins and adapted mold a channel in a tread molded in a mold provided with this mold element,
wherein the continuous bead comprises a part furthest away from the blades that is provided with at least one cavity adapted to mold a protrusion in a bottom of the channel molded by said continuous bead in a tread molded in a mold provided with this mold element, wherein said at least one cavity is formed so as to be centered on each pin.

8. The mold element according to claim 7, wherein each pin is of frustoconical shape of circular section, the largest-diameter section of these pins being adapted to mold a circular orifice on the tread surface.
